(19) United States
(12) Patent Application Publication
(10) Pub. No.: US 2021/0397992 A1
(43) Pub. Date: Dec. 23, 2021

(54) INFERENCE APPARATUS, INFORMATION PROCESSING APPARATUS, INFERENCE METHOD, PROGRAM AND RECORDING MEDIUM

(71) Applicant: NS Solutions Corporation, Tokyo (JP)

(72) Inventors: Masakazu KOMIYAMA, Tokyo (JP); Minoru EBISAWA, Tokyo (JP); Toshio NAGANO, Tokyo (JP); Shota YAMADA, Tokyo (JP); Kazuki IWAHASHI, Tokyo (JP)

(21) Appl. No.: 17/290,057

(22) PCT Filed: Nov. 7, 2019
(86) PCT No.: PCT/JP2019/043670

§ 371 Date: Apr. 29, 2021

(30) Foreign Application Priority Data
Nov. 9, 2018 (JP) 2018-211503

(51) Int. Cl. G06N 5/04; G06F 11/07; G06K 9/62; G06N 5/02

(52) U.S. Cl. CPC G06N 5/04; G06N 5/02; G06K 9/628; G06F 11/0772

(57) ABSTRACT

An inference apparatus makes an inference with respect to a phenomenon, the inference apparatus includes: a question acquirer configured to acquire a question related to the phenomenon; a question classifier configured to classify whether the question is a qualitative question or a quantitative question; a sensor classifier configured to classify whether sensor data is acquirable or not when the question is the quantitative question; a determiner configured to determine the sensor data as data to be used for the inference when the sensor data is acquirable and configured to determine input data by a user as the data to be used for the inference when the sensor data is unacquirable; and an inferrer configured to make the inference corresponding to the phenomenon using the data determined by the determiner.

### TECHNICAL FIELD

The present invention relates to an inference apparatus making an inference in response to input information, an information processing apparatus, an inference method, a program, and a recording medium.

### BACKGROUND ART

Conventionally, an expert system that makes an inference of a cause of a defect at manufacturing processes and makes an inference of countermeasures corresponding to the defect is known. The expert system asks a predetermined question to a user and makes the inference of the cause and the countermeasures based on an answer to it (the question) from the user.

Due to recent technological progress, an amount of data input from sensors has become enormous and thus a large amount of sensor data is also available in making an inference of the cause. Patent Literature 1 discloses an apparatus that makes an appropriate cause estimate by determining which one of data input from a user and sensor data is used as an answer.

### CITATION LIST

### Patent Literature

Patent Literature 1: Japanese Laid-open Patent Publication No. 2007-279840.

### SUMMARY OF INVENTION

### Technical Problem

However, in the technique disclosed in Patent Literature 1, it is necessary to grasp presence/absence of sensors in a monitoring target device and preset which one of the input data input by a user and the sensor data is prioritized, corresponding to the monitoring target device, and thus there is a problem of time-consuming work.

The present invention has been made in view of such problems. It is an object of the present invention to provide an inference apparatus that makes an appropriate inference with respect to a phenomenon without increasing cost.

### Solution to Problem

Accordingly, the present invention provides an inference apparatus for making an inference with respect to a phenomenon, the inference apparatus includes: a question acquirer configured to acquire a question related to the phenomenon; a question classifier configured to classify whether the question is a qualitative question or a quantitative question; a sensor classifier configured to classify whether sensor data is acquirable or not when the question is the quantitative question; a determiner configured to determine the sensor data as data to be used for the inference when the sensor data is acquirable and configured to determine input data by a user as the data to be used for the inference when the sensor data is unacquirable; and an inferrer configured to make the inference corresponding to the phenomenon using the data determined by the determiner.

### Advantageous Effects of Invention

The present invention provides an inference apparatus that makes an appropriate inference with respect to a phenomenon without increasing cost.

### BRIEF DESCRIPTION OF DRAWINGS

FIG. 1 is an overall configuration diagram of an inference system.

FIG. 2 is a hardware configuration diagram of an inference apparatus.

FIG. 3 is a functional configuration diagram of the inference apparatus.

FIG. 4 is a diagram illustrating a data configuration example of a question DB.

FIG. 5 is a diagram illustrating a data configuration example of a link DB.

FIG. 6 is a data configuration diagram of a candidate DB.

FIG. 7 is a conceptual diagram of a knowledge database.

FIG. 8 is a data configuration diagram of a word DB.

FIG. 9 is a flowchart illustrating an inference processing by the inference apparatus.

FIG. 10 is a flowchart illustrating an inference processing by the inference apparatus.

FIG. 11 is a diagram illustrating a display example in the inference processing.

FIG. 12 is a diagram illustrating a display example in the inference processing.

FIG. 13A is a diagram illustrating a display example in the inference processing.

FIG. 13B is a diagram illustrating a display example in the inference processing.

FIG. 13C is a diagram illustrating a display example in the inference processing.

### DESCRIPTION OF EMBODIMENTS

The following describes an embodiment of the present invention based on the drawings.

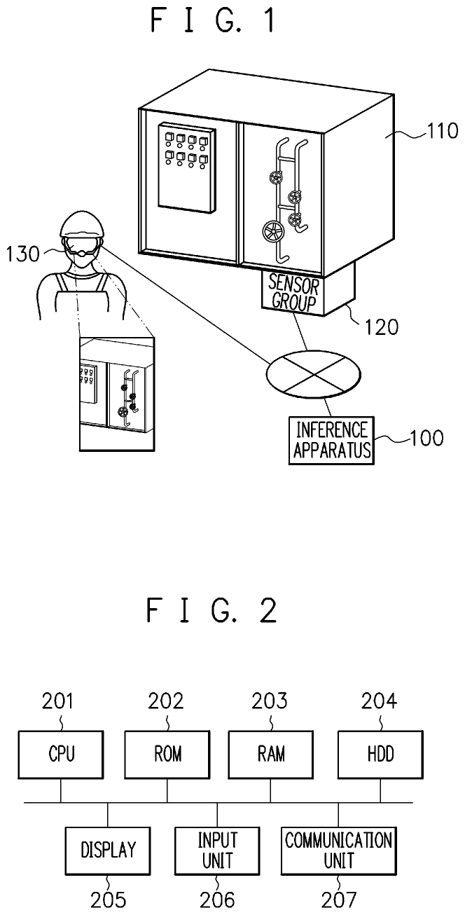

FIG. 1 is an overall configuration diagram of an inference system. The inference system is a system that, with respect to a phenomenon, makes an inference of, for example, its cause. In the embodiment, when a phenomenon such as a defect or abnormality in a monitoring target device occurs, the case where the inference system makes an inference of countermeasures with respect to the phenomenon will be described as an example. The phenomenon is not limited to, for example, a failure in the monitoring target device. An inference target is not limited to the countermeasure and may be the cause with respect to the phenomenon.

The inference system has an inference apparatus 100, a monitoring target device 110, a sensor group 120, and smart glasses 130. The sensor group 120 has a plurality of sensors that detect various kinds of pieces of information on the monitoring target device 110. The inference apparatus 100 is configured as, for example, a server or a cloud type information processing apparatus, and is communicatively connected to the sensor group 120 and the smart glasses 130 via, for example, a network. The inference apparatus 100 acquires various kinds of pieces of sensor data from the sensor group 120. The smart glasses 130 is a wearable device that superimposes and displays images in real space. The smart glasses 130 receives, for example, an inference result from the inference apparatus 100 and displays it. The smart glasses 130 further transmits user-input information to the inference apparatus 100. The inference apparatus 100 uses the sensor data and the input data input by a user at the smart glasses 130 to make the inference of the countermeasures for the device 110. It is only necessary that the device 110 is a device that can make the inference of the countermeasures by using two pieces of data of the sensor data and the input data, and the type of which is not specifically limited. As the device 110, for example, a DC cooling device is included. The inference apparatus 100 is not always connected only to the single device 110 and its sensor group 120 and may be configured to be communicatively connected to a plurality of devices and sensor groups and to make the inference with respect to the phenomenon related to those.

FIG. 2 is a hardware configuration diagram of the inference apparatus 100. The inference apparatus 100 has a CPU 201, a ROM 202, a RAM 203, an HDD 204, a display 205, an input unit 206, and a communication unit 207. The CPU 201 reads out control programs stored in the ROM 202 to execute various kinds of processes. The RAM 203 is used as a main memory of the CPU 201 and a temporary storage area of, for example, a work area. The HDD 204 stores, for example, various kinds of pieces of data and various kinds of programs. The display 205 displays various kinds of pieces of information. The input unit 206 has keyboards and a computer mouse to accept various kinds of operations by a user. The communication unit 207 executes communication processing with an external device such as a sensor via the network.

The functions and processes of the inference apparatus 100 described later are achieved by the CPU 201 reading out the programs stored in the ROM 202 or HDD 204 and executing the programs. In another example, instead of, for example, the ROM 202, the CPU 201 may read out programs stored in a recording medium such as an SD card.

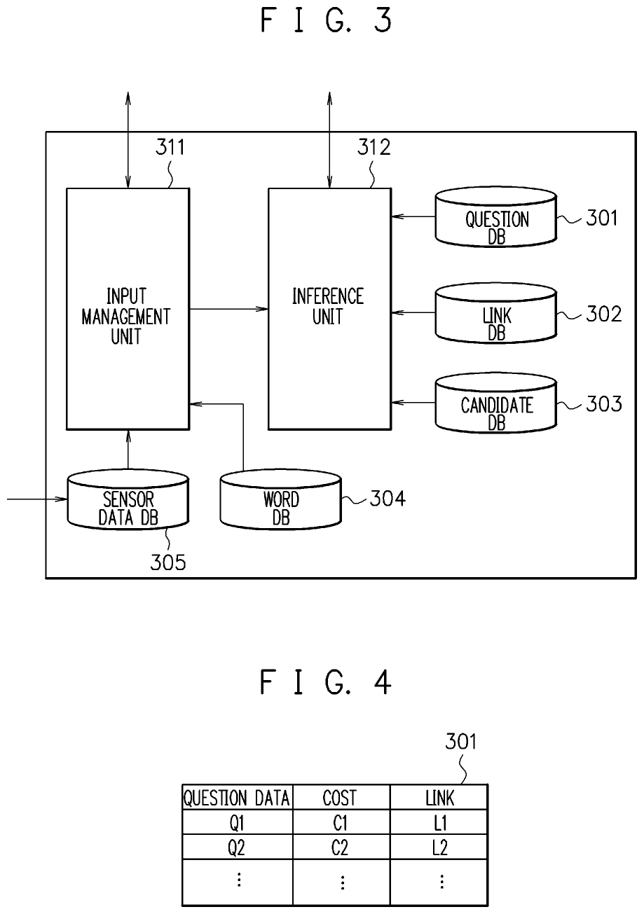

FIG. 3 is a functional configuration diagram of the inference apparatus 100. The inference apparatus 100 has a question DB 301, a link DB 302, a candidate DB 303, a word DB 304, a sensor data DB 305, an input management unit 311, and an inference unit 312.

FIG. 4 is a diagram illustrating a data configuration example of the question DB 301. The question DB 301 associates and stores question data, a cost, and a link. Here, the question data is question data that is necessary to make the inference of countermeasures. The cost is an index value indicating magnitude of a burden associated with an answer relative to the question data. For example, questions that cannot be answered without temporarily halting a process such as continuous casting causes a loss in answering. A high cost is set to such question data. Cost data is utilized as a classifying element at a time of selection of the question data and the question data with high-cost data becomes unlikely selected. This ensures reduced increase of cost. A link is information that associates candidate data described below with the question data.

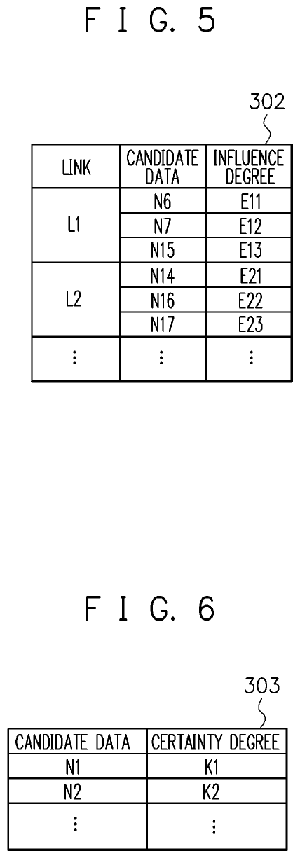

FIG. 5 is a diagram illustrating a data configuration example of the link DB 302. The link DB 302 associates and stores the link, the candidate data, and an influence degree. Here, the candidate data is data that becomes a candidate of the inference result by the inference unit 312. The influence degree is positive data or negative data allocated corresponding to a relationship between the question data and the candidate data. For example, in a case of a question used to select one of two pieces of the candidate data, positive data is allocated to one piece of the candidate data with respect to the question, and negative data is allocated to the other piece of the candidate data with respect to the question.

FIG. 6 is a data configuration diagram of the candidate DB 303. The candidate DB 303 associates and stores the candidate data and a certainty degree. Here, the certainty degree is a value that indicates certainty as the inference result of the candidate data. All the certainty degrees are set to be 50% at an initial state and the certainty degree is updated as needed in response to subsequent progress of an inference process.

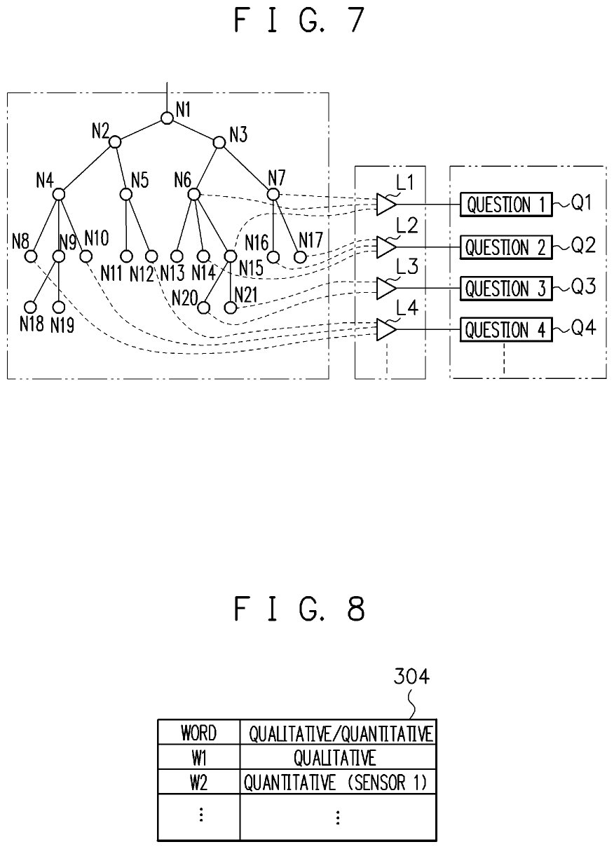

FIG. 7 is a conceptual diagram of a knowledge database that is achieved by the question DB 301, the link DB 302, and the candidate DB 303. Thus, the question data (Q1, Q2, . . . ) is associated with the candidate data (N1 to N21) by the link (L1, L2, . . . ). As shown in FIG. 7, the candidate data is hierarchized as a tree. Each piece of the question data is associated regardless of a hierarchy of the candidate data. That is, a plurality of pieces of the candidate data with different hierarchies can be associated with respect to one piece of the question data.

FIG. 8 is a data configuration diagram of the word DB 304. The word DB 304 associates and stores a word included in a question and a type of the question. Here, as the type of the question, there are two types of questions, namely qualitative questions, or quantitative questions. Here, the quantitative question is a question where the answer is acquirable as the sensor data, for example, such as whether temperatures of a device is within 10° C. to 20° C. or not. Meanwhile, the qualitative question is a question where the answer is unacquirable as the sensor data, for example, whether a device is dirty or not. The type of question shall be preliminarily set for each word. Furthermore, with respect to the quantitative question, information that indicates the type of sensor data is associated. The type of sensor data is a type, for example, values of the temperature and the humidity. The word DB 304 is one example of a correspondence table.

Referring again to FIG. 3, the inference unit 312 selects the question data with reference to the question DB 301, the link DB 302, and the candidate DB 303 to make the reference of the countermeasure based on answer data acquired with respect to the question data. The input management unit 311, based on the question data selected by the inference unit 312, determines which one of the input data input by a user and the sensor data input from the sensor group 120 is used as the data to be used for the inference. Then, the input management unit 311 passes the determined data to the inference unit 312. The input management unit 311, based on the question data, refers to the word DB 304 when determining the data to be used for the reference. The sensor data DB 305 stores the sensor data input from the sensor group 120.

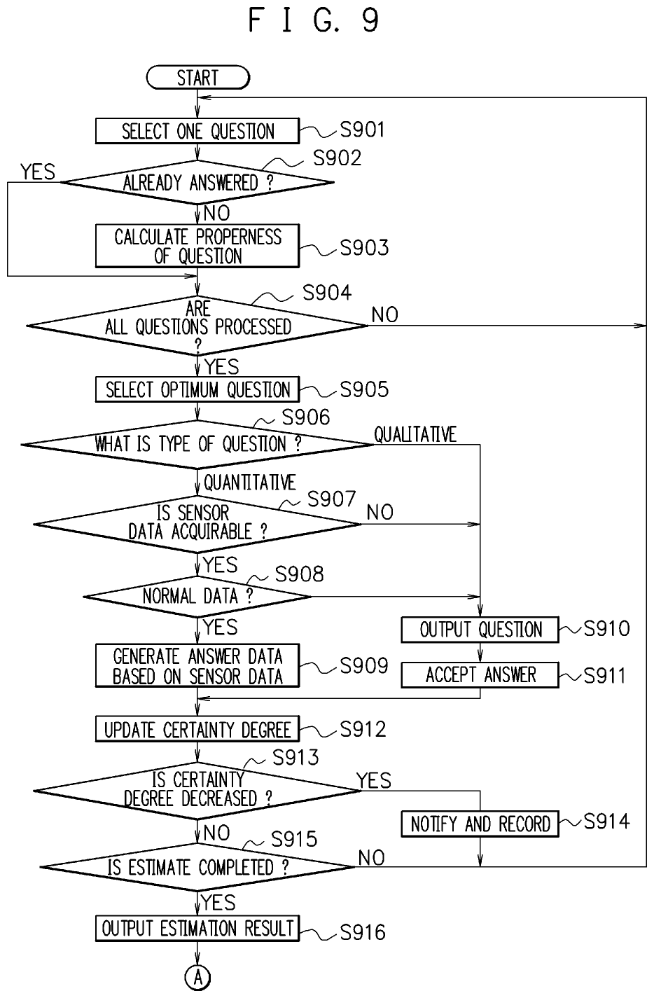

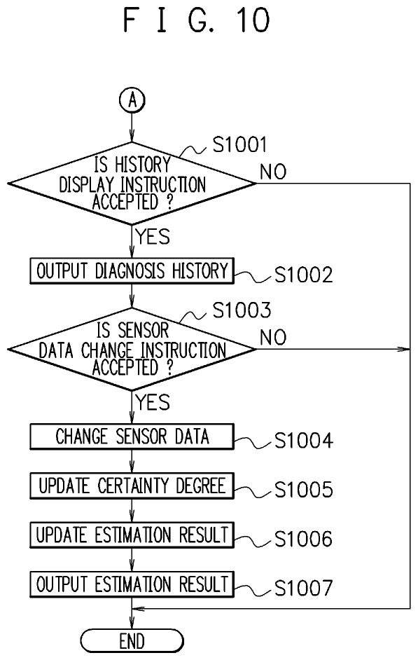

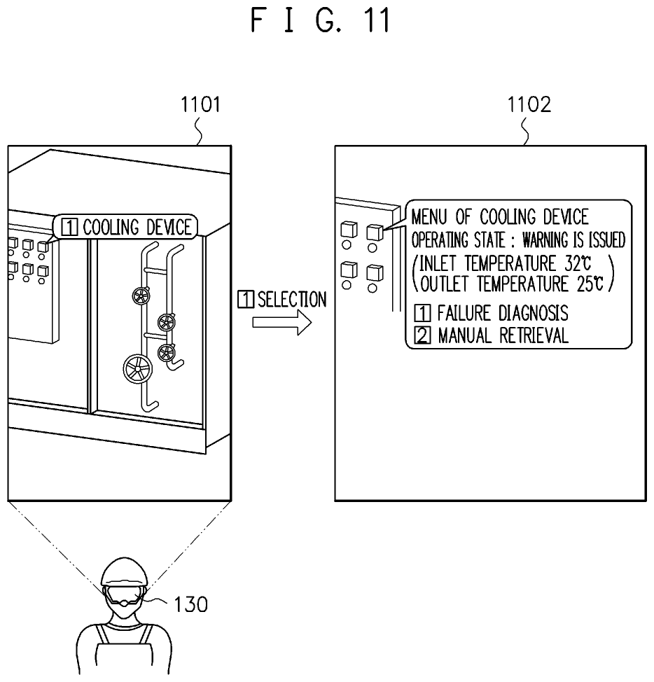

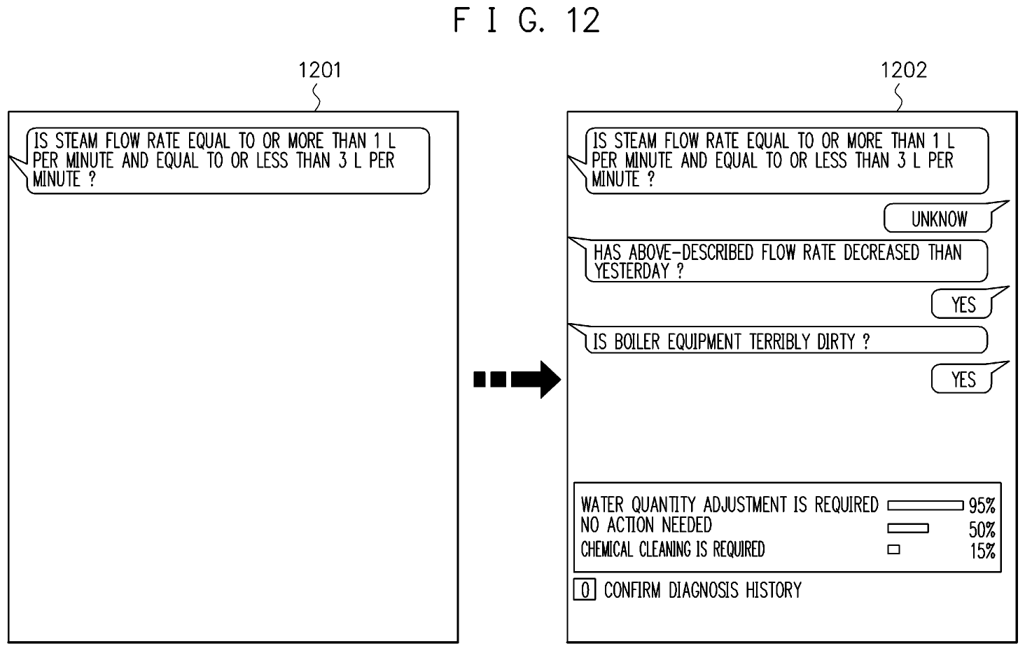

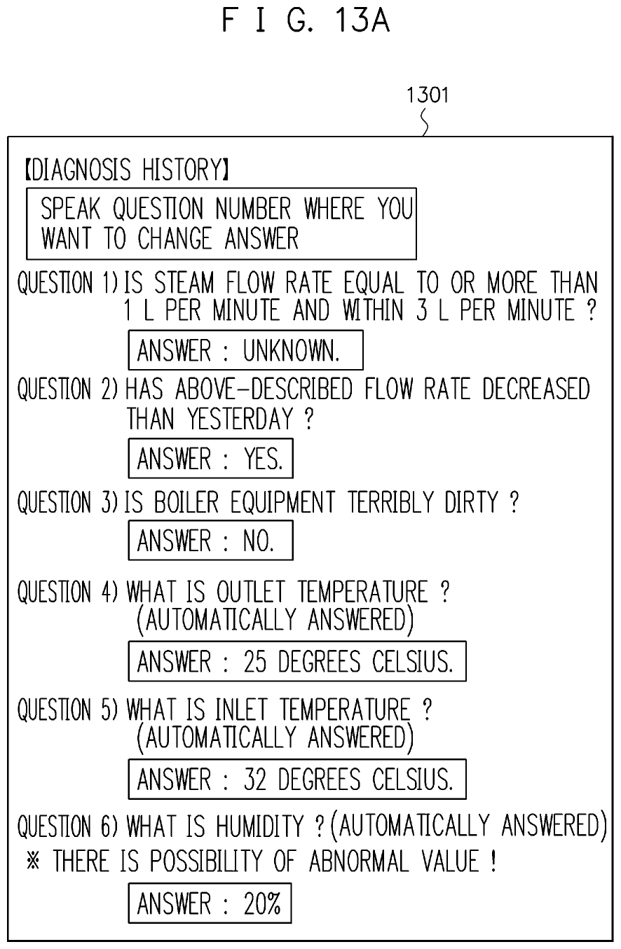

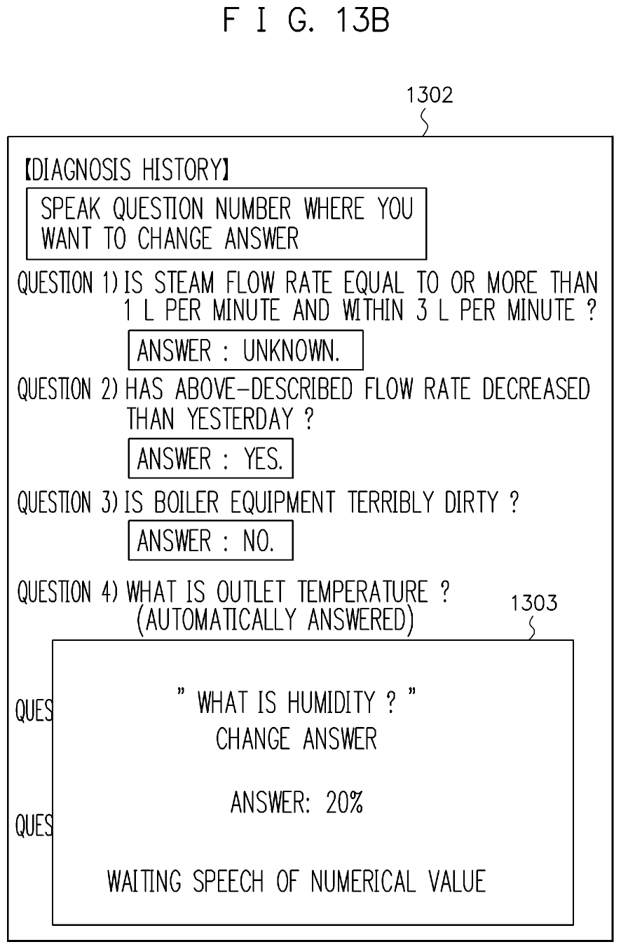

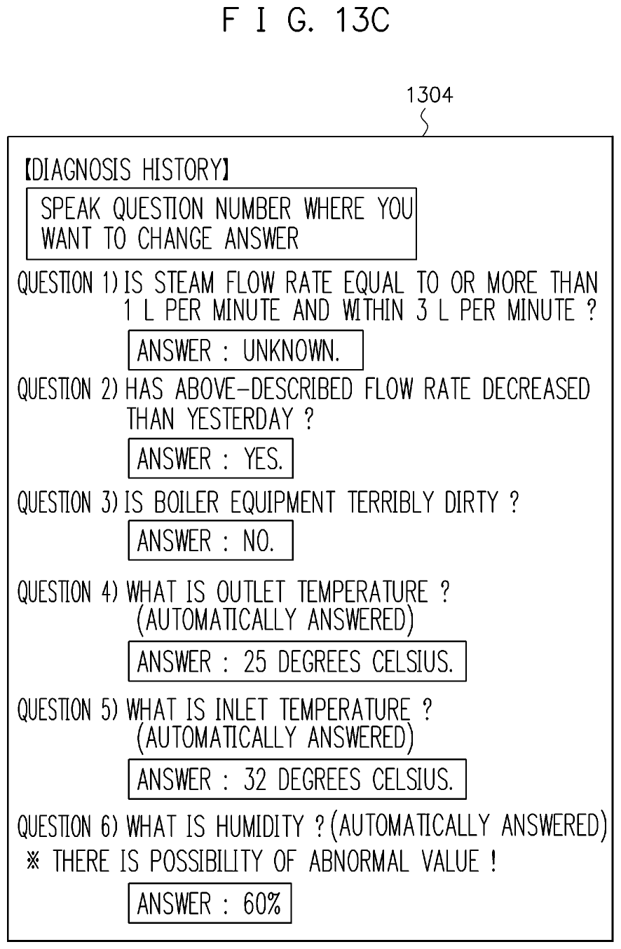

FIG. 9 and FIG. 10 are flowcharts illustrating inference processing by the inference apparatus 100. FIG. 11, FIG. 12, and FIG. 13A to FIG. 13C are diagrams illustrating display examples of the smart glasses 130 in the inference processing. As shown in FIG. 11, when an abnormality occurs, information that indicates an abnormality-generation source is displayed in the smart glasses 130, like a display example 1101. In the display example 1101, a cooling device is displayed. Furthermore, the cooling device is displayed as “1.” When a user speaks as “1” to select “1,” information indicative of a work relative to the cooling device is displayed, as shown in a display example 1102. Here, when the user selects “1,” a failure diagnosis (inference processing) is started. In the display examples shown in FIG. 11, FIG. 12, and FIG. 13A to FIG. 13C, for convenience of explanation, the real space that the user can visually perceive appropriately is omitted and only an image displayed in a superimposed manner is shown. However, in practice, the user that wears the smart glasses 130 can view the image displayed in FIG. 11, FIG. 12, and FIG. 13A to FIG. 13C, in a superimposed state in the real space.

In the inference processing, first at S901, the inference unit 312 selects any one piece of question data from the question DB 301. Next, at S902, the inference unit 312 determines whether the answer has already been acquired or not with respect to the selected question data. When the answer has been acquired (YES at S902), the inference unit 312 advances the process to S904. When the answer has not been acquired (NO at S902), the inference unit 312 advances the process to S903.

At S903, the inference unit 312 calculates a proper value of the question data. The inference unit 312 specifically calculates the proper value by (formula 1). The inference unit 312 shall obtain an effect by (formula 2). Here, the cost is a cost relative to the selected question data. The effect is an effect of the selected question data. The influence degree and the certainty degree are both an influence degree and a certainty degree corresponding to the candidate data associated with respect to the selected question data via the link. When a plurality of pieces of the candidate data are associated, the influence degree and the certainty degree corresponding to each of the plurality of pieces of the candidate data are used in (formula 2). For the influence degree, an absolute value shall be used.

proper value=cost×effect (formula 1)

effect=sum of (each influence degree×each certainty degree) (formula 2)

At S904, the inference unit 312 determines whether the process of calculating the proper values for all the question data is completed or not. When the process is completed for all the question data (YES at S904), the inference unit 312 advances the process to S905. When the unprocessed question data is present (NO at S904), the inference unit 312 advances the process to S901. In this case, at S901, the inference unit 312 selects the unprocessed question data again and performs the subsequent processes.

At S905, the inference unit 312 selects the optimum question data based on the proper value. Specifically, the inference unit 312 selects the question data where the proper value becomes a maximum value. Then, the inference unit 312 passes the selected question data to the input management unit 311.

Next, at S906, the input management unit 311 acquires the question data from the inference unit 312 and classifies the type of the acquired question data. Specifically, the input management unit 311 extracts a word included in the question data. Then, the input management unit 311 refers to the word DB 304 to identify whether the type associated with the word included in the question data is qualitative or quantitative. When a plurality of pieces of word data are extracted from the question data, the input management unit 311 shall identify the type of the question data from the plurality of words, in accordance with predetermined conditions. It is only necessary that the input management unit 311 identifies its type based on the question data, and the specific process for identifying the type is not limited to the embodiment. The process at S906 is one example of question acquisition processing and question classifying processing. When the question is quantitative (quantitative at S906), the input management unit 311 advances the process to S907. When the question is qualitative (qualitative at S906), the input management unit 311 advances the process to S910.

At S907, the input management unit 311 further refers to the word DB 304 to identify the type of the sensor data to be acquired. This process is one example of sensor identification processing. Then, the input management unit 311 classifies whether the identified type of sensor data is acquirable or not. The input management unit 311 distinguishes the type of sensor data that is acquirable, based on the sensor data input from the sensor group 120. The process at S907 is one example of sensor classifying processing. When the identified type of sensor date is acquirable (YES at S907), the input management unit 311 advances the process to S908. When the identified type of sensor date is unacquirable (NO at S907), the input management unit 311 advances the process to S910.

At S908, the input management unit 311 acquires the identified type of sensor data. This process is one example of sensor data acquisition processing. Then, the input management unit 311 classifies whether the sensor data is normal data or not. For example, in temperature data, when −10° C. is detected while the assumed detection temperature range is 10° C. to 20° C., it is likely that the corrective value has not been acquired due to, for example, abnormality in the sensor. The process at S908 is a process to eliminate such an unexpected value.

Specifically, in accordance with the predetermined conditions for each kind of piece of sensor data, the input management unit 311 classifies whether the sensor data acquired from the sensor group 120 is the normal data or not. For example, in the temperature data, when an acceptance range of 10° C. to 30° C. is defined, the input management unit 311 classifies that the acquired sensor data is the normal data when the acquired sensor data is the data within the acceptance range, and classifies that the acquired sensor data is not the normal data when the acquired sensor data is the data outside the acceptance range. As another example, the input management unit 311 may classify whether it is the normal data or not based on a time series variation of the temperatures data already detected at a time point of the process. The input management unit 311, for example, predicts the next value of the sensor data from the time series variation, and then may classify that the acquired sensor data is the normal data when the acquired sensor data has a value within a predetermined range from the predicted value and classify that the acquired sensor data is not the normal data when the acquired sensor data does not have a value within the predetermined range. The process at S908 is one example of data classifying processing.

When the acquired sensor data is the normal data (YES at S908), the input management unit 311 advances the process to S909. When the acquired sensor data is not the normal data (NO at S908), the input management unit 311 advances the process to S910.

At S909, the inference unit 312 generates answer data from the sensor data acquired at S908. In this embodiment, the question data can be answered by any of YES, NO, and UNK (UNKNOWN). The input management unit 311 generates any of YES, NO, and UNK as the answer data from the sensor data. The input management unit 311, after the process at S909, advances the process to S912.

On the other hand, at S910, the input management unit 311 controls so as to output the question data to the smart glasses 130 via the communication unit 207. In a display example 1201 shown in FIG. 12, the question data of “Is steam flow rate equal to or more than 1 L per minute and equal to or less than 3 L per minute?” is displayed. In response to this, the user enters an answer relative to the question data. At S911, the input management unit 311 accepts the input data (the answer data) input by the user via the communication unit 207. Here, the answer data to be accepted is any of YES, NO, and UNK as described above. The input management unit 311, after the process at S911, advances the process to S912.

At S912, based on the answer data acquired at S909 or S911, the input management unit 311 updates the certainty degree relative to each of the plurality of pieces of the candidate data associated with the selected question data. Specifically, when the answer data is YES, the input management unit 311 increases the certainty degree of all the candidate data associated with the question data by a predetermined amount. On the other hand, when the answer data is NO, the input management unit 311 decreases the certainty degree of all the candidate data associated with the question data by a predetermined amount. In the case of UNK, the certainty degree is not changed. The process at S912 is one example of inference processing.

At S913, the input management unit 311 classifies whether the certainty degree of the predetermined candidate data has been decreased or not. The processes of S901 to S915 are the repetition process. Repeatedly updating the certainty degree in accordance with the answer data gradually increases the value of the certainty degree of the candidate data closer to the countermeasures. Thus, when the certainty degree is decreased after the certainty degree is increased to some extent, it is likely that the answer data is erroneous. The process at S913 is a process that classifies the possibility of such an error of the answer data.

The input management unit 311 selects the candidate data that matches with the predetermined conditions, for example, the candidate data where the certainty degree shows a maximum value or the candidate data where the certainty degree has become equal to or more than a threshold value, as a processing target. Then, the input management unit 311, with respect to the candidate data as the processing target, classifies whether the certainty degree calculated at preceding S912 is decreased compared to the certainty degree before the calculation or not. When the certainty degree is decreased (YES at S913), the input management unit 311 advances the process to S914. When the certainty degree is not decreased (NO at S913), the input management unit 311 advances the process to S915.

At S914, the input management unit 311 records the fact that the answer data is likely to be erroneous in association with the selected question data. Furthermore, the input management unit 311 controls the display 205 to display the information indicating a fact that the answer data is likely to be erroneous. When the certainty degree is updated to be decreased at S912, namely, when the certainty degree is updated to be decreased based on the sensor data, the sensor data is likely to be abnormal. The input management unit 311 may record and display the information so that the sensor data can be identified as being likely to be abnormal in this way. After the process at S914, the input management unit 311 advances the process to S915. The process that displays the information indicating the possibility of the error may be omitted.

At S915, the input management unit 311 classifies whether an estimate is completed or not. The input management unit 311 classifies that the estimate is completed when the maximum value of the certainty degree is equal to or more than the predetermined threshold value. When the estimate is completed (YES at S915), the input management unit 311 advances the process to S916. When the estimate is not completed (NO at S915), the input management unit 311 advances the process to S901.

At S916, the input management unit 311 transmits an estimation result to the smart glasses 130 via the communication unit 207. This process is one example of output processing that outputs the estimation result. When receiving the estimation result, the smart glasses 130 displays it. As the estimation result, the input management unit 311 transmits the candidate data where the certainty degree is equal to or more than the threshold value to the smart glasses 130 together with the certainty degree. When a large number of pieces of the candidate data where the certainty degree is equal to or more than the threshold value are present, the input management unit 311 transmits a predetermined number of pieces of the candidate data, in descending order, and the certainty degrees corresponding to it to the smart glasses 130. Corresponding to this, as a display example 1202 in FIG. 12, the candidate data with the high certainty degree is displayed on the smart glasses 130 together with the certainty degree. In the display example 1202, the candidate data up to the 3rd place is displayed.

Next, at S1001 shown in FIG. 10, the inference unit 312 classifies whether a history display instruction is accepted from the smart glasses 130 or not. For example, when the user speaks “0” corresponding to “confirm a diagnosis history” indicated in the display example 1202 in FIG. 12, the history display instruction shall be transmitted to the inference apparatus 100 from the smart glasses 130. Here, the history display instruction is information that instructs to display diagnosis history information. The diagnosis history information is information that indicates the question used in the process of estimating a diagnostic result and its answer along the time series. When the history display instruction is accepted (YES at S1001), the inference unit 312 advances the process to S1002. When the history display instruction is not accepted (NO at S1001), the inference unit 312 terminates the inference processing.

At S1002, the inference unit 312 outputs the diagnosis history information. A display example 1301 of the diagnosis history information is indicated in FIG. 13A. In the display example 1301, questions 1 to 6 and their answers are displayed. Of these, in the questions 4 to 6, “(automatically answered)” is indicated after the question sentence. These indicates that the inference apparatus 100 has automatically acquired the sensor data as the answer, without confirming to the user. Thus, the user can confirm the question where the sensor data has been used and its answer. Furthermore, in the question 6, “* there is a possibility of an abnormal value!” is indicated. In the process at S914 described with reference to FIG. 9, the answer data where the fact that the answer data is likely to be erroneous is recorded is thus identifiably displayed for the user. This enables the user to confirm whether the answer data is correct or not.

Here, when confirming the answer to the question 6 and determining that the input of the sensor data is erroneous, the user can change it by user operation. For example, assume that the user determines that the humidity of 20% in the answer with respect to the question 6 is incorrect. In this case, the user speaks “6”. Corresponding to this, as shown in a display example 1302 in FIG. 13B, the smart glasses 130 displays a window 1303 for entering a value after change. Here, the user enters the value after the change, for example, enters 60%. Corresponding to this, as shown in a display example 1304 in FIG. 13C, the smart glasses 130 updates the answer to the question 6. Subsequently, when the user speaks “rediagnosis,” the smart glasses 130 transmits a sensor data change instruction indicating that the answer to the question 6 will be changed to 60% to the inference apparatus 100.

Corresponding to this, at S1003, the inference unit 312 classifies whether the sensor data change instruction is accepted or not. When the sensor data change instruction is accepted (YES at S1003), the inference unit 312 advances the process to S1004. When the sensor data change instruction is not accepted (NO at S1003), the inference unit 312 terminates the inference processing. At S1004, the inference unit 312 changes the sensor data in accordance with the sensor data change instruction. For example, when the sensor data change instruction indicating that the answer to the question 6 is changed to 60% is accepted, the sensor data as the answer to the question 6 is changed from 20% to 60%.

Next, at S1005, based on the answer data after having been changed at S1004, the inference unit 312 updates the certainty degree relative to the candidate data associated with the corresponding question data. This process is similar to the process of updating the certainty degree at S912. Next, at S1006, the inference unit 312 updates the estimation result corresponding to the certainty degree after the update. Next, at S1007, the inference unit 312 transmits the estimation result after the update to the smart glasses 130 via the communication unit 207. When receiving the estimation result, the smart glasses 130 updates the display of the estimation result in response to the received estimation result.

As described above, in the inference system according to the embodiment, the inference apparatus 100 determines which one of the input data by a user and the sensor data is used as the answer data, corresponding to the question data. Furthermore, when the sensor data is not present or when the sensor data indicate an abnormal value, the inference apparatus 100 acquires the user input. Thus, the inference apparatus 100 of the embodiment classifies whether the sensor data can be used as the answer data or not from the content of the question. Consequently, it is not necessary to confirm the presence/absence of the sensor data for each monitoring target device and establish a DB that preliminarily sets which one of the sensor data and the input data is used for each piece of the question data. Thus, the inference apparatus 100 can make an appropriate inference with respect to a phenomenon without increasing cost.

As a first modification example of the embodiment, the hardware configuration of the inference system is not limited to the embodiment. As another example, the input management unit 311 and the inference unit 312 may be achieved in a different information processing apparatus. In this case, it is only necessary that the information processing apparatus that functions as the input management unit 311 receives the question data from the information processing apparatus that functions as the inference unit 312, generates the answer data corresponding to the question data, and transmits the answer data to the information processing apparatus that functions as the inference unit 312. Thus, at least a part of the functions and the processes of the inference apparatus 100 may be achieved by, for example, causing a plurality of CPUs, RAMs, ROMs, and storages to cooperate with one another. In another example, at least a part of the functions and the processes of the inference apparatus 100 may be achieved by using a hardware circuit. The hardware displaying, for example, the inference result is not limited to the smart glasses 130, in another example, may be a display of, for example, a PC that a user uses.

As a second modification example, the type of the sensor data that the inference apparatus 100 refers to in making the inference may be one. In this case, no processing for identifying the type of the sensor is required, and in the word DB 304, no information indicating the type of the sensor is required.

As a third modification example, while, in the embodiment, the diagnosis history information is outputted after completion of the inference, an output timing of the diagnosis history information is not limited to the embodiment. As another example, the diagnosis history information may be appropriately outputted corresponding to a user operation before the completion of the inference. In this case, the inference apparatus 100 outputs the question that is already acquired and its answer as the diagnosis history information. Furthermore, when the sensor data change instruction is accepted, the inference apparatus 100 may update the already-acquired answer and then advance the inference.

### Other Embodiment

The present invention is also achieved by executing the following processing. That is, the processing is as follows: the software (programs) that achieves the functions of the above-described embodiment is supplied to a system or an apparatus via a network or various kinds of recording medium. Then, the computer (or, for example, the CPU or the MPU) of the system or the apparatus reads out and executes the programs.

As described above, with each embodiment described above, it is possible to provide the inference apparatus that makes an appropriate inference with respect to a phenomenon, without increasing cost.

As described above, while the preferred embodiment of the present invention has been described in detail, the present invention is not limited to those specific embodiments and various kinds of modifications and changes can be made within a scope of the spirit of the present invention described in the claims.

1. An inference apparatus for making an inference with respect to a phenomenon comprising:
a question acquirer configured to acquire a question related to the phenomenon;
a question classifier configured to classify whether the question is a qualitative question or a quantitative question;
a sensor classifier configured to classify whether sensor data is acquirable or not when the question is the quantitative question;
a determiner configured to determine the sensor data as data to be used for the inference when the sensor data is acquirable and configured to determine input data by a user as the data to be used for the inference when the sensor data is unacquirable; and
an inferrer configured to make the inference corresponding to the phenomenon using the data determined by the determiner.

2. The inference apparatus according to claim 1, further comprising:
a sensor data acquirer configured to acquire the sensor data when the sensor data is acquirable; and
a data classifier configured to classify whether the sensor data acquired by the sensor data acquirer is normal data or not based on a predetermined condition, wherein
the determiner determines the sensor data as the data to be used for the inference when the sensor data is the normal data and determines the input data as the data to be used for the inference when the sensor data is not normal data.

3. The inference apparatus according to claim 2, wherein
the data classifier classifies whether the sensor data is the normal data or not based on whether a value of the sensor data is a value within a predetermined acceptance range or not.

4. The inference apparatus according to claim 2, wherein
the data classifier classifies whether the sensor data is the normal data or not based on a time series variation of the sensor data detected before a time point of processing.

5. The inference apparatus according to claim 1, comprising:
a first outputter configured to output data that is determined by the determiner and is to be used for the inference; and
a changer configured to change the data to be used for the inference when a change instruction of the data to be used for the inference is accepted, wherein
when the data to be used for the inference is changed by the changer, the inferrer makes the inference using the data after the change.

6. The inference apparatus according to claim 1, wherein
the inferrer, at each time when the data to be used for the inference is determined, makes the inference using the data to be used for the inference and calculates a certainty degree of an inference result, and
the inference apparatus further comprises a recorder configured to record information indicating a fact that when, after calculation of a first certainty degree relative to the inference result, the certainty degree has changed to a second certainty degree smaller than the first certainty degree by the inference where the sensor data has been used, the sensor data is likely to be erroneous, to a storage.

7. The inference apparatus according to claim 6, further comprising
a second outputter configured to output the information indicating a fact of presence of the error.

8. The inference apparatus according to claim 1, wherein
the question classifier classifies whether the question is a qualitative question or a quantitative question based on a word included in the question.

9. The inference apparatus according to claim 1, wherein
the question classifier refers to a correspondence table where a word and information indicating whether the word is qualitative or quantitative are associated, and classifies whether the question is the qualitative question or the quantitative question based on the word included in the question.

10. The inference apparatus according to claim 9, wherein
the correspondence table further stores information indicating a type of a sensor in association with the information indicating the quantitativeness,
the inference apparatus further comprises a sensor identifier configured to refer to the correspondence table and identify the type of the sensor based on the word included in the question, and
the sensor classifier classifies whether sensor data corresponding to the type of the sensor identified by the sensor identifier is acquirable or not.

11. An information processing apparatus comprising:
a question acquirer configured to acquire a question related to a phenomenon;
a question classifier configured to classify whether the question is a qualitative question or a quantitative question;
a sensor classifier configured to classify whether sensor data is acquirable or not when the question is the quantitative question; and
a determiner configured to determine the sensor data as data to be used for an inference when the sensor data is acquirable and configured to determine input data by a user as the data to be used for the inference when the sensor data is unacquirable.

12. An inference method for making an inference with respect to a phenomenon comprising:
a question acquiring step of acquiring a question related to the phenomenon;
a question classifying step of classifying whether the question is a qualitative question or a quantitative question;
a sensor classifying step of classifying whether sensor data is acquirable or not when the question is the quantitative question;
a determining step of determining the sensor data as data to be used for the inference when the sensor data is acquirable and determines input data by a user as the data to be used for the inference when the sensor data is unacquirable; and
an inferring step of making the inference corresponding to the phenomenon using the data determined at the determining step.

13. (canceled)

14. A computer readable recording medium that records a program for causing a computer to function as:
a question acquirer configured to acquire a question related to a phenomenon;
a question classifier configured to classify whether the question is a qualitative question or a quantitative question;
a sensor classifier configured to classify whether sensor data is acquirable or not when the question is the quantitative question;
a determiner configured to determine the sensor data as data to be used for the inference when the sensor data is acquirable and configured to determine input data by a user as the data to be used for the inference when the sensor data is unacquirable; and
an inferrer configured to make the inference corresponding to the phenomenon using the data determined by the determiner.
